(19) United States
(12) Patent Application Publication
(10) Pub. No.: US 2026/0138378 A1
(43) Pub. Date: May 21, 2026

(54) METHOD AND APPARATUS FOR AN ARCHITECTURE TO APPLY A TWO-STEP PRETREATMENT

(71) Applicant: XEROX CORPORATION, NORWALK, CT (US)

(72) Inventors: Jorge A. Alvarez, Webster, NY (US); Jason M. LeFevre, Penfield, NY (US); Seemit Praharaj, Webster, NY (US); Anthony S. Condello, Webster, NY (US); Douglas K. Herrmann, Webster, NY (US)

(73) Assignee: XEROX CORPORATION, NORWALK, CT (US)

(21) Appl. No.: 18/950,778

(22) Filed: Nov. 18, 2024

(51) Int. Cl. B41J 2/21; B41J 11/00

(52) U.S. Cl. CPC B41J 2/21; B41J 11/0015

(57) ABSTRACT

A method and system for pretreating media in an aqueous ink jet printing system is disclosed. A powder is deposited on a first surface of the media, an aqueous solution is deposited on the first surface of the media to dissolve the powder on the first surface of the media to form a pretreatment composition, and a pigmented ink can be subsequently deposited on or near the pretreatment composition. The method and system for pretreating media in an aqueous ink jet printing system can include monitoring a property of the media or adjusting an amount or a deposition pattern of powder deposited on the first surface of the media based on the property of the media. Depositing an aqueous solution and depositing the pigmented ink can be done using a multichannel printhead.

### TECHNICAL FIELD

The present teachings relate generally to aqueous ink jet printing systems and, more particularly, to pretreatment methods and apparatus for pre-treatment applications.

### BACKGROUND

Digital aqueous ink jet (AIJ) printing is an area of growth for several production class printing systems. Printers or consumers of printed materials making or considering a transition from a dry powder (electrophotographic) printing system to an aqueous ink jet printing system or printing press require the maintenance of existing image quality (IQ) and print permanence and durability characteristics while reducing run cost per kiloprint (kp). Exemplary printing systems using the aqueous ink jet printing methods have significantly improved print image quality matching or exceeding current electrophotographic printing methods.

The image quality of aqueous ink images printed onto various types of media varies according to the type of media being printed. Image quality is typically exemplary when the aqueous ink is printed onto offset coated, non-glossy media because the ink remains on top of the coating. Aqueous ink printing onto uncoated, porous media, however, produces washed out, poorer quality images because the inks are absorbed into the fibers of the paper. To avoid this consequence, coatings can be applied to porous media to reduce the absorption of the inks into the media. Primers, also known as precoat or pretreatment solutions, reduce the interaction of the inks with the media since the primer is interposed between the media and the inks. Because the ink image is fixed to the primer layer rather than the media, the ink image can be more easily removed. The ease of ink image removal from media is a significant factor in recycling printed media. In systems using inkjet printheads to apply primer, or precoat solutions, to print media, it is important to understand and provide mitigation interventions for missing or misdirected jets in a precoat application system.

Therefore, it is desirable to develop or design methods or systems to provide uniform placement of precoat or pretreatment solutions on print media in aqueous based ink jet printing systems.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for pretreating media in an aqueous ink jet printing system is disclosed. The method includes depositing a powder on a first surface of the media, depositing an aqueous solution on the first surface of the media to dissolve the powder on the first surface of the media to form a pretreatment composition, and depositing a pigmented ink on or near the pretreatment composition. Implementations of the method for pretreating media in an aqueous ink jet printing system can include monitoring a property of the media. The method for pretreating media in an aqueous ink jet printing system may include adjusting an amount or a deposition pattern of powder deposited on the first surface of the media based on the property of the media. The method for pretreating media in an aqueous ink jet printing system can include adjusting an amount or a deposition pattern of the aqueous solution deposited on the first surface of the media based on the property of the media. The property of the media may include media absorbency, surface roughness, environmental storage conditions, or a combination thereof. Depositing a powder on a first surface of the media may include spraying the powder. The powder may include calcium, magnesium, or a combination thereof. Depositing the aqueous solution may include jetting the aqueous solution from a printhead, and the aqueous solution is deposited at a drop volume of from about 2 picoliters to about 20 picoliters. The aqueous solution may include polyvinyl alcohol, a cation, a biocide, or a combination thereof. Depositing an aqueous solution and depositing the pigmented ink can be done with a multichannel printhead, and the multichannel printhead may include a first channel and a second channel that are not in fluid communication with one another. Implementations of the described techniques may include hardware, a method or process, or computer software on a computer-accessible medium.

A system for pretreating media in an aqueous inkjet printing system is disclosed. The system includes a powder deposition device configured to deposit a layer of powder on a surface of the media. The system also includes a multichannel printhead, which can include a first channel may include a source of an aqueous solution, and a second channel which can include a source of a pigmented ink. The system also includes a media path configured to transport the media in proximity to the powder deposition device and the multichannel printhead. The system also includes where the first channel and the second channel are not in fluid communication with one another. Implementations of the system for pretreating media in an aqueous inkjet printing system can include where the media is transported in proximity to the powder deposition device before being transported in proximity to the multichannel printhead. The system for pretreating media in an aqueous inkjet printing system may include a sensor to measure a property of the media. The property of the media can include media absorbency, surface roughness, environmental storage conditions, or a combination thereof. The powder may include calcium, magnesium, or a combination thereof. The aqueous solution is deposited at a drop volume of from about 2 picoliters to about 20 picoliters. The aqueous solution may include polyvinyl alcohol, a cation, a biocide, or a combination thereof.

An aqueous ink jet printing system is disclosed. The aqueous ink jet printing system includes a powder deposition device configured to deposit a layer of powder on a surface of a media. The system also includes a multichannel printhead, which may include a first channel may include a source of an aqueous solution, and a second channel including a source of a pigmented ink. The system includes a media path configured to transport the media in proximity to the powder deposition device and the multichannel printhead, and where the powder may include calcium, magnesium, or a combination thereof, the aqueous solution may include polyvinyl alcohol, a cation, a biocide, or a combination thereof, and the aqueous solution is deposited at a drop volume of from about 2 picoliters to about 20 picoliters. Implementations of the aqueous ink jet printing system can include where the first channel and the second channel are not in fluid communication with one another. The aqueous ink jet printing system may include a sensor to measure a property of the media.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 is a schematic diagram of a system and method for pre-coating paper prior to ink jet printing, in accordance with the present disclosure.

FIG. 2 is a schematic of an application device for a portion of a pre-coat treatment for an ink jet printing system, in accordance with the present disclosure.

FIGS. 3A and 3B are plots depicting mottle and graininess of pre-treated prints compared to untreated prints, respectively, in accordance with the present disclosure.

FIGS. 4A and 4B are a top-perspective view and a bottom-facing view of a multichannel printhead, respectively, in accordance with the present disclosure.

FIG. 5 is a flowchart illustrating a method for pre-coating paper prior to ink jet printing, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The apparatus and methods of the present disclosure solves the problem of improving deposition of primer or pre-coat solution in an aqueous ink jet printing system, where the primer or precoat is used to improve print quality and de-inkability in production ink jet printing presses. To address this issue, a method and system are proposed to deposit a precoat or pretreatment to a print prior to being printed with aqueous ink with the use of a two-part composition and deposition means. The precoat composition, precoat, primer, or primer material, can include an aqueous-soluble salt that can be applied as a two-part material and eventually form a solution that improves ink adhesion and de-inkability by “crashing” or precipitating the ink pigment portion of the ink composition and preventing it from sinking or diffusing into the bulk of the paper. As used herein, the term “primer” or “precoat” can be defined as coatings, materials, or solutions that are applied to media, commonly paper, to improve the image quality of the ink images over that which is achieved without the coatings. The use of a salt composition or solution as a precoat material has several advantages, including low material cost and the ability to improve print quality on both coated and uncoated paper. The effect of “crashing,” precipitating, or causing the precipitation of a component of an ink can include any single chemical or combination of chemicals in relation to a printed ink or other printing related fluid that can facilitate the desolubilization or precipitation of one or more components in the ink. The desolubilizing can be accomplished by proton transfer from collision or close proximity of a crashing agent with one or more of the ink components. The desolubilizing can be caused by component associations induced by a combination of a precoat solution and/or component associations occurring with the precoat solution. An additional feature of the primer or precoat composition is that it is an inherently colorless precoat material and thus does not effect colors of any ink droplets or patches upon interaction under normal use.

The mechanism by which the precoat solution crashes or causes the precipitation of the ink pigments at the surface is alternatively reasoned to be via the breaking of the surface tension of the ink which causes the pigments, dyes, or other components to precipitate and adhere to the surface of the paper. The use of a powder deposition system and an inkjet print head to deposit a primer composition or solution provides a uniform and consistent coating of the solution on the paper, thus ensuring that the solution sufficiently covers all areas of the paper.

The precoat material used in this method can be any suitable composition that helps ensure even coverage of a first predetermined pattern onto the diagnostic media or under normal printing operating conditions. In one example, the precoat material, once combined, comprises 5% wt to 40% wt of a salt in an aqueous solution based on a total weight of the aqueous solution or composition. Additional details related to the precoat material composition or primer are described in greater detail herein.

The precoat material, also referred to as a precoat composition, precoat, primer, or primer solution, can include an aqueous salt solution that improves ink adhesion and de-inkability by “crashing” the ink pigment portion of the ink composition and preventing it from sinking or diffusing into the bulk of the paper. A distinguishing feature of the present disclosure includes where the precoat material is applied in two parts, for example as a first deposition of a powder material, and a second deposition of a liquid or solution that can dissolve the first deposition of powder to form a solution. It should be noted that references herein to solution should be considered to describe or refer to a solution of pretreatment material once both parts are combined. As used in this document, the term “primer” or “precoat” can be defined as coatings or solutions that are applied to media to improve the image quality of the ink images over that which is achieved without the coatings. The use of a salt solution as a precoat solution has several advantages, including low material cost and the ability to improve print quality on both coated and uncoated paper. The effect of “crashing,” precipitating, or causing the precipitation of a component of an ink can include any single chemical or combination of chemicals in relation to a printed ink or other printing related fluid that can facilitate the desolubilization or precipitation of one or more components in the ink. The desolubilizing can be accomplished by proton transfer from collision or close proximity of a crashing agent with one or more of the ink components. The desolubilizing can be caused by component associations induced by a combination of a precoat solution and/or component associations occurring with the precoat solution.

The mechanism by which the precoat solution crashes or causes the precipitation of the ink pigments at the surface is alternatively reasoned to be via the breaking of the surface tension of the ink which causes the pigments, dyes, or other components to precipitate and adhere to the surface of the paper. The use of a powder deposition followed by a deposition of an aqueous solution to achieve the application of the precoat solution and in so providing a uniform and consistent coating of the solution on the paper. For the purposes of this disclosure, any suitable print media, such as paper or another printable substrate, such as, but not limited to coated paper, uncoated paper, plastic films, plastic sheets, fabrics, or other printable materials can be used interchangeably. Typically, when a precoat solution, primer, ink or other material is deposited on a substrate, a first side of the substrate is commonly facing the hydrophobic compliant application member, the printheads or any other printing system component that modifies the first side or first surface of the substrate or paper. A second side may subsequently undergo a similar process, during which time it may be considered as a second side of a substrate or paper, which is a common practice when printing in duplex mode for a printing system.

Potential drawbacks or limitations of using a salt solution as a precoat solution can include the possibility of damaging the paper if too much salt is applied, or too high a content of salt is included in the salt solution, leading to the possibility of the solution being or becoming too concentrated, thus causing the ink density to increase. The precoat solution or the individual components thereof and their respective deposition can be adjusted to improve its effectiveness on different types of paper by varying the concentration of the respective components of the solution and the number of passes through the system, or both. The number of passes through the system can affect the amount of salt in the precoat solution by increasing the concentration of the solution on the surface of the paper. The amount of precoat can alternatively be adjusted by deposition parameters in the print head.

Precoat solutions of the present teachings may alternatively be used with other types of inks, such as dye-based inks, but the precoat solutions may not be as effective in improving the quality of the print. The precoat solution can be compared to other pre-coating methods, such as those used in competitive products, by providing a simpler and more cost-effective solution. It also provides improved IQ metrics and de-inking capabilities.

In examples, the precoat composition and application system can be used with other types of paper surfaces, substrates, or coatings, such as UV coatings or laminates, but it may not be as effective in improving the quality of the print as when used with uncoated papers. The use and application of a precoat composition or solution can impact the print quality and durability of the final print by improving the IQ metrics and de-inking capabilities, which can lead to a higher-quality print. The precoat solution may be used with different types of printing equipment, such as digital printers or offset presses, but it may require some modifications to the equipment to ensure that it works effectively in such equipment.

In essence, the precoat application system is configured to apply a precoat solution, disposed on at least a portion of a surface of the media, wherein a first powder or solid deposition system deposits a powder or portion of a precoat composition onto a media surface, followed by a printhead delivering a quantity of solution to a surface of media and onto the precoat powder portion, in some examples, paper or other sheet or web delivered substrate, when the media is passed in proximity to a printhead configured to jet or eject a plurality of droplets of precoat aqueous solution, and the precoat materials are deposited on the surface of the paper to obtain a uniform coating of the precoat solution on the surface of the paper upon mixing and dissolving. In examples, the precoat solution can include an aqueous salt solution. For example, the precoat solution can include magnesium chloride, calcium nitrate, barium, any water soluble salt of Ca²⁺, Mg²⁺, Ba²⁺, B³⁺, Al³⁺, or combinations thereof. In essence, divalent or trivalent cations are the active species included in a precoat solution. They destabilize one or more of the ink components, colloids, latex, pigments, and the like, and cause them to precipitate out of suspension or dispersion within the ink composition. A representative primer, primer solution, or precoat solution composition can be found in Table 1. All values are represented in % by weight of a total precoat solution or primer composition.

TABLE 1
Representative Precoat (Primer) Solution Composition

| | Amt in | % by | Suitable Range |
|---|---|---|---|
| Chemical | 1 kg | wt | (% by wt) |
| Glycerol | 21.8 | 2.2 | 0-5 |
| Propylene Glycol, | 197.7 | 19.8 | 10-40 |
| (can also include other cosolvents | | | |
| like butanediol, pentanediol, | | | |
| hexanediol, glycol ethers like | | | |
| diethylene glycol monoethyl ether, | | | |
| dipropylene glycol methyl ether, | | | |
| similar to cosolvents that may | | | |
| be present in ink formulations) | | | |
| Water | 509 | 50.9 | 30-70 |
| Magnesium Nitrate Hexahydrate | 270 | 27.0 | 10-50 |
| (can also include other metal | | | |
| salts as described herein) | | | |
| Surfactant TT4000 | 7 | 0.7 | 0.1-3 |
| Biocide Proxel | 1.45 | 0.1 | 0.1-1 |

In an example, the precoat solution comprises a magnesium chloride solution in water, where in any case, the precoat solution can include 5% wt to 40% wt of a salt in an aqueous solution based on a total weight of the aqueous solution. Other examples include from about 1% wt to about 50% wt, or from about 10% wt to about 50% wt, or from about 10% wt to about 20% wt of a salt in an aqueous solution based on a total weight of the aqueous solution.

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

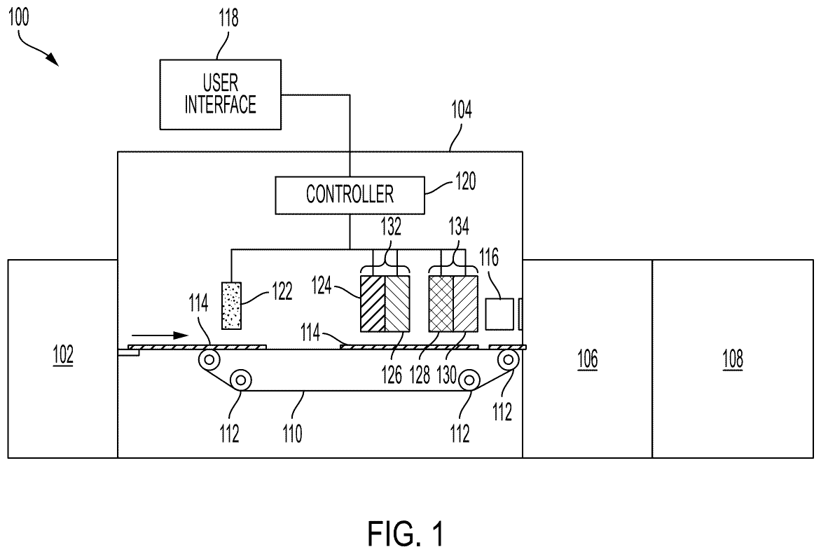

FIG. 1 is a schematic diagram of a system and method for pre-coating paper prior to ink jet printing, in accordance with the present disclosure. The system and method for pre-coating paper prior to ink jet printing can be integrated in entirety, or in part, into a high-speed color inkjet printer 100. FIG. 1 depicts a high-speed color inkjet printer 100 that uses a two-stage or two-step pretreatment application method to apply precoat solution or primer to media in the printer to enable media to have improved image quality. As illustrated, the printer 100 is a printer that directly forms an ink image on a surface of a media sheet stripped from one of the supplies of media sheets stored within a paper feeder 102 and the sheets are moved through the printer 100 in a process direction (as indicated by a directional arrow) by a controller 120 operating one or more of the actuators that are operatively connected to rollers or to at least one driving roller of conveyor that comprise a portion of the media transport 110 that passes through the print engine module 104 of the printer. In one example, each printhead module has only one printhead that has a width that corresponds to a width of the widest media in the cross-process direction that can be printed by the printer. In other examples, the printhead modules have a plurality of printheads with each printhead having a width that is less than a width of the widest media in the cross-process direction that the printer can print. In these modules, the printheads are multichannel printheads arranged in an array of staggered printheads or a linear array of printheads that abut one another to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. In still other examples, one or more sections of a multichannel printhead can be configured to deposit an aqueous solution that comprises primer or a solution for a primer composition. The printer 100 can be configured with three or more sheet supplies, each containing a different type or size of media.

With further reference to FIG. 1, the printed image exits the print engine module 104 having a print zone of printer 100 and passes under one or more image dryers 106 after the ink image is printed on a sheet, represented herein as a more generic media 114. As used in this document, the term “print zone” means an area of a media transport opposite the printheads of an inkjet printer. The image dryer 106 can include an infrared heater, a heated air blower, air returns, or combinations of these components to heat the ink image and at least partially fix an ink image to the sheet. An infrared heater applies infrared heat to the printed image on the surface of the sheet to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer. In normal printing operations, the media 114 or sheet is jetted upon with ink or primer or precoat solution in an imagewise fashion and transported through the print zone to create a multicolor image. In examples of the present disclosure, the media 114 includes a primer application module for applying a solid powder portion of a precoat composition or primer to the media.

Prior to reaching the print zone, the media 114 passes beneath a precoat, or primer application module 122. The primer application module 122 includes one or more sprayheads or powder deposition nozzles configured to deposit a uniform layer of a solid, powder portion of a pretreatment composition. This layer of primer is deposited onto the media prior to the media being printed by the multichannel printheads 132, 134. A first multichannel printhead 132 includes a primer solution 124, and an ink jetting printhead module 124. A second multichannel printhead 134 includes two ink jetting printhead modules 128, 130. In examples, the arrangement of the four sections 124, 126, 128, 130 of the two multichannel printheads 132, 134 can include various configurations of primer components or ink, but it is understood that the application of the primer solution, which dissolves the previously deposited powder component of the pretreatment, should be conducted first, before any ink is deposited on the paper, and further to avoid cross-contamination between any primer component and the aqueous ink. The location and presence of primer applied to the media 114 can be measured by a detector 116. In examples, the detector 116 can be inline and positioned within the printing system 100 or can be external to the printer 100, such that the presence of applied primer can be evaluated offline. The signal generated by the detector can be a visual signal, perceptible by an operator, or provided to the controller 120 via an inline scanner, image analysis or detector. An inline scanner is considered to be inline with respect to the process such that scanning can occur within a printing machine during normal operation and without undue interruption. The controller 120 is configured with programmed instructions stored in non-transitory, computer readable media that when executed cause the controller to identify the amount and thickness of primer on the media and adjust the operation of the primer application module 122 to correct the application of the primer for the type of media being printed in normal operation, or indicate a need for a manual operation or intervention by a machine operator.

In examples of a printer 100 as shown and described herein, a return path for printing duplex, or two-sided images can be employed, as well as an accompanying duplex path and controller instructions as needed. FIG. 1 also shows the printed sheets or diagnostic media as being collected in the output module 108, but in examples, they can be directed to other processing stations (not shown) that perform tasks such as folding, collating, binding, and stapling of the media sheets.

Operation and control of the various subsystems, components and functions of the machine or printer 100 are performed with the aid of a controller or electronic subsystem (ESS) 120. The ESS or controller 120 is operatively connected to the components of the printhead modules 124, 126, 128, and 130 (and also the multichannel modules 132, 134), the detector, the image dryer 106, output module 108 and other system components not necessarily shown herein for purposes of clarity. The ESS or controller 120, for example, is a self-contained computer having a central processor unit (CPU) with electronic data storage, and a display or user interface (UI) 118. The ESS or controller 120, for example, includes a sensor input and control circuit as well as a pixel placement and control circuit. In addition, the controller 120 reads, captures, prepares, and manages the image data flow between image input sources, such as a scanning system or an online or a work station connection (not shown), and the printhead modules 124, 126, 128, and 130. As such, the ESS or controller 120 is the main multi-tasking processor for operating and controlling all of the other machine subsystems and functions, including the printing process.

The controller 120 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below when the programmed instructions are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 120 from either a scanning system or an online or work station connection for processing and generation of the printhead control signals output to the printhead modules 124, 126, 128, and 130 (and also the multichannel modules 132, 134). Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

In examples of the system for pretreating media in an aqueous inkjet printing system, the system includes a powder deposition device configured to deposit a layer of powder on a surface of the media and a multichannel printhead, comprising a first channel comprising a source of an aqueous solution, and a second channel comprising a source of a pigmented ink, and a media path configured to transport the media in proximity to the powder deposition device and the multichannel printhead, wherein the first channel and the second channel are not in fluid communication with one another. In examples, the media is transported in proximity to the powder deposition device before being transported in proximity to the multichannel printhead. One or more sensors can be included in the system for pretreating media in an aqueous inkjet printing system where a sensor can be used to measure one or more properties of the media. Measurable media properties can include a property of the media such as media absorbency, surface roughness, environmental storage conditions, or a combination thereof. The powder deposited by the powder deposition device can include a first part or first component of the pretreatment composition, and include calcium, magnesium, or a combination thereof. The aqueous solution deposited by a first channel of the multichannel printhead can be deposited at a drop volume of from about 2 picoliters to about 20 picoliters. The aqueous solution of the second pretreatment composition component can include polyvinyl alcohol, a cation, a biocide, or a combination thereof.

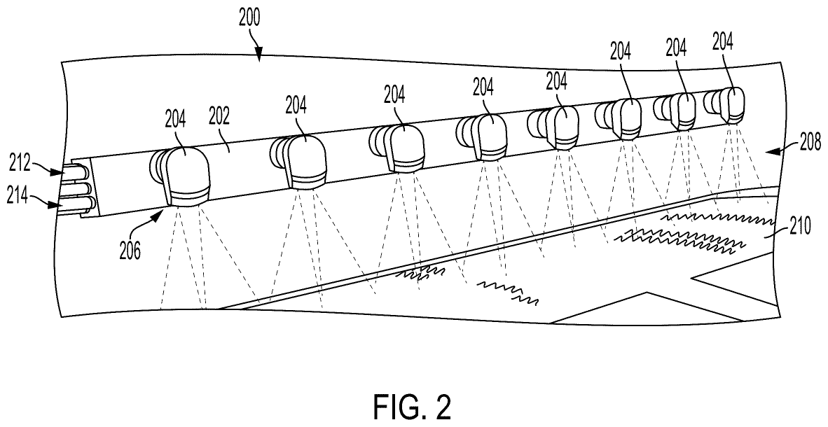

FIG. 2 is a schematic of an application device for a portion of a pre-coat treatment for an ink jet printing system, in accordance with the present disclosure. The solid pretreatment application device 200 includes a manifold 202 in connection with one or more sprayheads 204, with each sprayhead 204 including a plurality of nozzles 206 for spraying powder 208 onto a surface of a media 210. The application device 200 further includes a material inlet 212 for introducing pressure and material through the application device 200 and a material outlet 214 for recycling a pressure gas or materials throughout the application device 200 and accompanying system for material supply and delivery.

By separating the pre-treat composition key components, a more controllable means of pretreating the media can be employed. The chemical composition of a pre-treat fluid or composition is a mixture of salts such as calcium, magnesium, or a mixture of the two using water and biocides as a carrier. The following is an example of a known pre-treat fluid 20% Cation (Na+), 10% PVA, 70% Water. Polyvinyl alcohol (PVA) is a synthetic polymer that is made from vinyl alcohol. It is a white, odorless, and tasteless solid that is soluble in water. PVA is used in a variety of applications, including adhesives, textiles, and food packaging. It should be noted that there are many variations of pretreat fluids which are customized to the inks and the application methods. Some jetting methods will require in addition to water a surfactant or co-solvent like glycerin for optimal jetting and interaction with the inks. Other ingredients can include water, glycerol, flame retardants, surfactants, or combinations thereof.

The separation of the salts and the carrier and the separate application of both onto the media prior to jetting pigmented ink can be referred to as a two-step application of the pretreat. The salts can be sprayed on the media using a typical powder sprayer such as those used in offset printing, and as depicted in FIG. 2. Offset presses often apply anti-set-off powder at the output to keep the printed pages from sticking to each other before they are fully dry. The powder used by offset is usually food grade starch particles with a mean diameter of as low as 5 μm to as large as 70 μm. The present disclosure further includes using such a powder deposition device to spray the salts that are needed to crash out the pigment and achieve de-inkability. This would be done at a substantial distance upstream from the print heads to avoid contamination. Once deposited, the salts may be freely deposited on the media and could be susceptible to being dislodged by the action of transporting the media. It is proposed to lock the salts into the paper fibers ahead of printing on the media by jetting a fluid using the first channel of the first printhead. The proposed fluid is mostly comprised of water. The fluid could further include small amounts of biocide. The purpose of the fluid is to wet the media and quickly dissolve the salts into the paper fibers. The fluid would be fairly simple to jet as it is mostly water. The fluid should not have any impact to the channel next to it as it would not cause any pigment to crash out and clog jets. If a system was configured with a reverse osmosis system on demand, the fluid should require no biocides as fresh treated water would be available at all times. It should also be noted that un-coated medias can absorb considerable amounts of fluid before requiring active drying, as compared to other types of media, such as coated media.

Designs such as those shown can enable precise control over salt deposition rates and be dependent upon specific paper properties during pre-treatment processing. The spray pattern may be adjusted based on substrate texture and absorbency rate using sensors that monitor real-time changes in surface characteristics. For instance, with extremely rough surfaces or high-absorbent papers, present system may increase powder deposition while adjusting water jetting frequencies accordingly.

In one example, the salt-containing composition is deposited onto media through a spray nozzle having multiple nozzles arranged to create an array of fine droplets that may be adjusted for uniform coverage. The sprayer air flow rate and pressure can be controlled independently or in combination with other parameters like temperature and humidity to optimize powder distribution on various substrates. The use of different types of salt-containing powders, such as calcium carbonate (CaCO₃) or magnesium oxide (MgO), which may be tailored for specific applications. For instance, CaCO₃ may provide better de-inkability properties while MgO may enhance print quality and color gamut on certain media. Other types of salts used can include any water soluble, or partially water soluble, such as calcium (Ca), magnesium (Mg), or aluminum (Al) salt, including carbonates, nitrates, oxides, or combinations thereof. Any water-soluble material that generates enough cations to precipitate ink constituents. In general, the salt type could be selected based on the ink components and pigment choice to maximize image quality (IQ) or de-inkability, or balance multiple aspects.

The powder sprayer can be integrated with a precision-controlled air flow system that enables precise control over salt deposition rates by adjusting airflow velocity or pressure to match specific paper types, allowing for real-time adjustments based on substrate characteristics during pre-treatment processing. The proposed system can also include sensors and algorithms to monitor and adjust spray patterns in response to changing environmental conditions, such as temperature fluctuations. In a further example, the powder sprayer is designed with interchangeable nozzles or nozzle arrays that can be swapped out depending on specific media types. This allows for flexibility when working with various substrates without requiring extensive recalibration of the system.

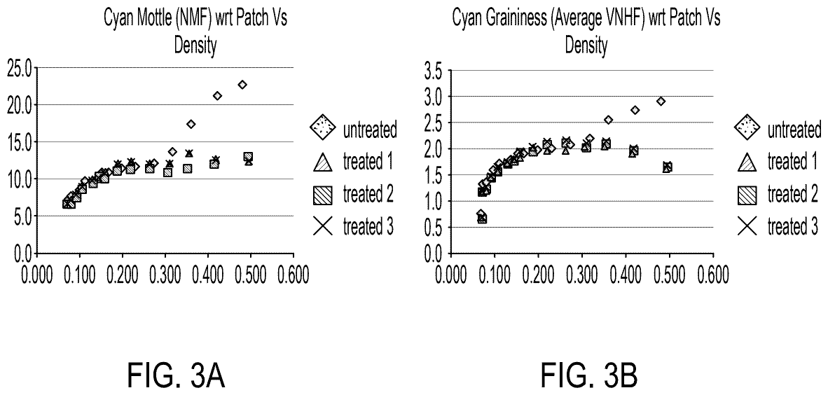

FIGS. 3A and 3B are plots depicting mottle and graininess of pre-treated prints compared to untreated prints, respectively, in accordance with the present disclosure. It can be shown that uncoated media with pre-treat will have increased color gamut and improved graininess as evidenced by the plots in FIGS. 3A and 3B. Experiments can be conducted to further match optimum amounts of precoat salts to media types. It has also been shown that de-inkability of aqueous inks is better achieved when the media is pre-treated prior to jetting pigmented inks on the media. The amount of salts at the spray step can also be tailored to media roughness or top surface characteristics to maximize the image quality improvement or de-inking grade. The printhead delivering the water fluid could also jet different amounts of water per page to match a pre-selected amount of salts sprayed on the media. Jetting drops can be tunable between about 2 picoliters to about 5 picoliters and rendered to different ink limits, such as from about 4 picoliters to about 16 picoliters in a 6×6 HT cell. This jetting performance can be achieved using typical print heads in the market today. After pretreat deposition and mixing in the two print process steps, the salts and the water are fully dispersed and ready to accept ink. The two steps involved are the spraying of salts and the jetting of water on the previously deposited salts. The water salt combination allowing a cation would be instantaneous and similar in time scale to ink spreading on the media. The mean diameter of the salt, from about 5 to about 7 microns can be optimized to provide a faster reaction with water. For example, the salt can have a mean diameter of from about 10 microns or below. In some examples, powders for such applications can be from about 3 microns to about 50 microns, or from about 10 microns to about 30 microns.

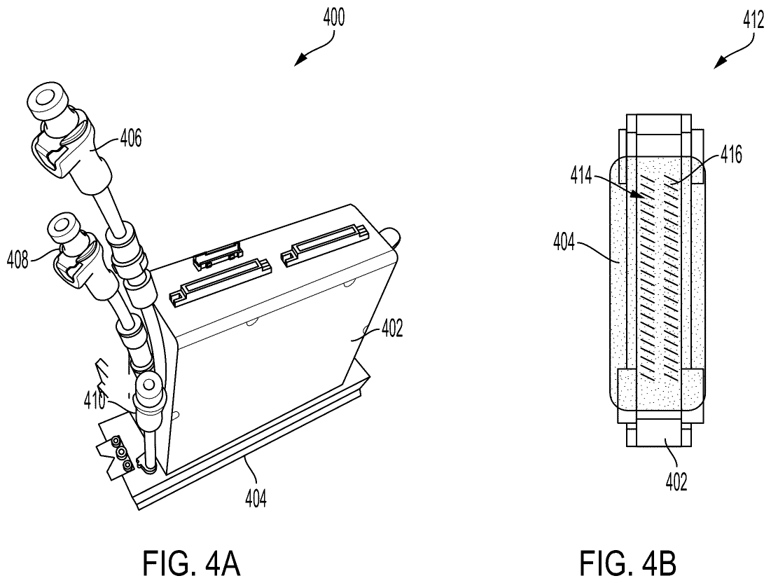

FIGS. 4A and 4B are a top-perspective view and a bottom-facing view of a multichannel printhead, respectively, in accordance with the present disclosure. FIG. 4A depicts a multichannel printhead 400 includes a housing 402 and a face plate 404, with a first material inlet and first material outlet 410 connected to the housing 402 and configured to deliver ink or water-based solutions to the face plate 404. A second material inlet 408 is also present and configured to deliver a second material, such as an ink or water-based solution to the face plate 404. In the bottom-facing view 412 of the multichannel printhead of FIG. 4B, a first channel jet array 414 and a second channel jet array 416 are shown within the face plate 404. Other key elements for a lower cost system architecture include the aforementioned multichannel print, for example, a 1200 dpi single channel printhead can also be offered as a two-channel x 600 dpi. The trade-off for having two fluids in the same head is half the resolution per channel in the direction perpendicular to the direction of the paper movement. Such a two-channel print head configuration can have water on the first channel, and the next channel will have ink, for example, cyan ink. The second printhead will house magenta and yellow ink in such an example. This enables the delivery of a composite black color when requiring a black color and a limited gamut due to the lack of black ink.

In examples, to address varying media types and print quality requirements, a drop volume adjustment mechanism is implemented within the first channel to match optimal salt treatment levels (e.g., 200 g/L) based on substrate properties like absorbency rate. The system also incorporates sensors for real-time monitoring of paper texture and composition adjustments during the first step. In an example where inkjet nozzles become clogged due to pigment crashing, regular cleaning and flushing routines are performed using specialized solvents to prevent buildup from occurring within the first channel or other channels. Capping systems integrate dedicated maintenance procedures without cross-contamination between fluids on shared faceplates.

In examples, a dedicated capillary system can be integrated into each water channel to facilitate precise control over fluid flow rates during maintenance procedures. The capping mechanism features adjustable nozzles with precisely calibrated air pressure settings for optimal sealing and purging of the channels without compromising print quality or introducing contaminants from other fluids used in the process. Another example incorporates a specialized purge module that utilizes compressed gas (e.g., nitrogen) to flush out residual water droplets, ensuring complete removal of any remaining fluid residue within each channel. This design minimizes waste generation during maintenance operations and reduces potential environmental impact while maintaining print quality standards. Furthermore, present separate capping system for water channel may be adapted to accommodate various printhead configurations by incorporating interchangeable capillary modules or adjustable nozzles that cater specifically to different print modes (e.g., high-quality vs. standard quality) or media types used in the printing process. In yet another example, an automated cleaning mechanism employs a combination of air jets, solvents, and gentle agitation (e.g., ultrasonic or vibrational) to remove any residual ink particles from the nozzles after capping. This ensures optimal print quality is maintained by preventing potential blockages caused by dried-up inks. Reduction of these maintenance procedures can be enabled by using the system of the present disclosure.

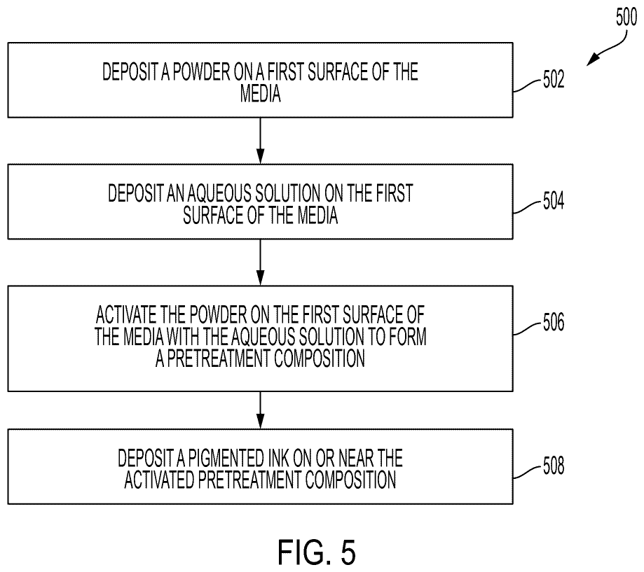

FIG. 5 is a flowchart illustrating a method for pre-coating paper prior to ink jet printing, in accordance with the present disclosure. The method 500 for pretreating media in an aqueous ink jet printing system, includes the steps of depositing a powder on a first surface of the media 502, depositing an aqueous solution on the first surface of the media 504, dissolving the powder on the first surface of the media with the aqueous solution to form a pretreatment composition 506, and depositing a pigmented ink on or near the dissolved pretreatment composition 508. In some examples, the method 500 includes monitoring a property of the media and in some examples, adjusting an amount or a deposition pattern of powder deposited on the first surface of the media based on the property of the media, such as media absorbency, surface roughness, environmental storage conditions, or a combination thereof. In examples, the method 500 includes adjusting an amount or a deposition pattern of the aqueous solution deposited on the first surface of the media based on the property of the media. The deposition of the powder can occur by spraying a solid powder onto the media. Other examples of powder applications can include electrostatic or ionization driven deposition, or via the use of pneumatic shakers, similar to cascade, or gravity fed development processes. In examples, depositing the aqueous solution comprises jetting the aqueous solution from a printhead, wherein the aqueous solution is deposited at a drop volume of from about 2 picoliters to about 20 picoliters. The solution can include, among other ingredients described herein, a polyvinyl alcohol, a cation, a biocide, or a combination thereof.

Various test targets can be used to test many, as much as 1500 patches or more, with varying amounts of ink combinations to produce pantone colors. The black patch generated by black ink only and the black patch generated by the suitable combination of CMY inks are very similar in Lstar and Optical Density [OD]. In examples where print modes using CMY ink combinations, the speed of the media can be lowered to as much as half the full speed as to increase the resolution of the images in the direction of the media travel, yielding images of 600×1200 dpi as example with increased resolution in the process direction. This can be referred to as a high quality mode where more ink can be delivered per unit area of the printed image and thus achieve higher color gamut and image smoothness. Uncoated media can readily accept higher levels of ink before requiring active drying. Typical Lstar values of the primary colors and secondary colors using standard pigments in aqueous ink jetting systems yield Lstar values for black ink and process black (using only CMY inks) show little difference without the aid of optical density measurement instruments.

The following Table 1 shows the projected water usage to help assess the impact to run cost. The use cases are for 4, 6, and 9 picolitres (pL) of drop volume. The starting projection to match equivalent salt levels in pre-treat would be 200 grams of salt per liter of fluid jetted at printhead_1 channel_1. In other words, a low level of treatment at 4 pL water drops would require 200 grams of salt and treat >7K impressions, or page sides. When the media requires higher levels of salt treatment, the system can switch to a larger drop volume to match higher spray rates. As an example, pre-made solutions contain 700 grams of water and 200 grams of salt and 100 grams of biocide and surfactant per one liter of finished solution.

TABLE 1
Projected water usage

| | dpi | area in | area in | | | Salt per | | | liters of | # |
|---|---|---|---|---|---|---|---|---|---|---|
| drop vol | [600 × | A4 page | A4 page | drops per | fluid per A4 | A4page | Salt | | fluid per A4 | pages/ |
| [pl] | 600] | [inch inch] | [cm cm] | page | page [pl] | [grams/page] | gram/cm\hat{ }2 | [pl/liter] | page | liter |
| 4 | 600 | 96.7 | 624 | 34812000 | 139,248,000 | 0.02785 | 0.0000446 | 1.00E+12 | 0.000139 | 7,181 |
| 6 | 600 | 96.7 | 624 | 34812000 | 208,872,000 | 0.04177 | 0.0000669 | 1.00E+12 | 0.000209 | 4,788 |
| 9 | 600 | 96.7 | 624 | 34812000 | 313,308,000 | 0.06266 | 0.0001004 | 1.00E+12 | 0.000313 | 3,192 |

Aspects of the present disclosure include at least one multichannel print head configured to jet water and pigmented ink, a means for depositing salts onto the media surface using offset press technology prior to activation by water, wherein the first channel is configured to deposit an aqueous solution, and the second channel is configured to deposit a pigmented ink, as a two-step pre-treat application process. A powder sprayer device can further be configured to adjust its spray pattern and salt deposition rates according to specific paper properties. The at least one multichannel print head is configured with two channels for water jetting and pigmented ink jetting respectively. The use of sensors monitoring real-time changes in substrate texture and composition during pre-treatment can be used to adjust salt deposition rates accordingly.

Aspects include where the multichannel print head is designed with separate channels for water-only or pigmented-ink only capping systems integration. A biocide can be incorporated in the carrier fluid used during pre-treatment to prevent microbial growth within printhead nozzles and other components. The at least one multichannel print head is designed with separate channels for water-only or pigmented-ink only capping systems integration using specialized solvents for cleaning and flushing each channel during maintenance routines. The system includes a means to adjust drop volume in response to specific print requirements based on factors such as media absorbency, surface roughness, inkjet performance requirements, or environmental conditions. The at least one multichannel print head is designed with separate channels for water-only or pigmented-ink only capping systems integration using specialized solvents during maintenance routines to prevent nozzle blockages and ensure consistent print quality throughout production runs.

The present disclosure provides a way to separate the pre-treat components such as the salts and the carrier fluid. The salts can be deposited away from the printheads. The first jetting section of the printing system can then jet water to lock the salts into the media fibers. Enabling jetting of the pre-treat carrier fluid in a multichannel printhead to complete the two-step pre-treat application can minimize printhead failures related to pigment crashing at the nozzle and printhead plate.

Advantages include avoiding print head failures related to jetting pre-treat and ink in a single multichannel printhead, enabling print head maintenance and caping as the water would not induce failures on the shared faceplate with pigmented ink on the same printhead. The use of yellow, magenta, and cyan inks would help reduce the hardware needed to jet inks with acceptable color gamut volume, providing availability of two print bars with 4 jetting fluids. Printhead and print bars are one of the highest cost components in an aqueous ink jet printer. A three-color system allows the use of the unavailable channel for a portion of the two-step pretreat. The capping and maintenance system for the water channel does not require separate waste lines or maintenance hardware as the pigmented inks. The separation of the salts followed by the jetting of its suitable carrier fluid, including water, biocide, etc., can minimize print head contamination that could lead to clogged nozzles due to pigment crashing on the faceplate. The implementation of pretreat methods such as described can make the printed product suitable for de-inking, improve image quality in graininess and mottle by using pretreat as described herein.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for pretreating media in an aqueous ink jet printing system, comprising:
depositing a powder on a first surface of the media;
depositing an aqueous solution on the first surface of the media to dissolve the powder on the first surface of the media to form a pretreatment composition; and
depositing a pigmented ink on or near the pretreatment composition.

2. The method for pretreating media in an aqueous ink jet printing system of claim 1, further comprising monitoring a property of the media.

3. The method for pretreating media in an aqueous ink jet printing system of claim 2, further comprising adjusting an amount or a deposition pattern of powder deposited on the first surface of the media based on the property of the media.

4. The method for pretreating media in an aqueous ink jet printing system of claim 2, further comprising adjusting an amount or a deposition pattern of the aqueous solution deposited on the first surface of the media based on the property of the media.

5. The method for pretreating media in an aqueous ink jet printing system of claim 2, wherein the property of the media comprises media absorbency, surface roughness, environmental storage conditions, or a combination thereof.

6. The method for pretreating media in an aqueous ink jet printing system of claim 1, wherein depositing a powder on a first surface of the media comprises spraying the powder.

7. The method for pretreating media in an aqueous ink jet printing system of claim 1, wherein the powder comprises calcium, magnesium, or a combination thereof.

8. The method for pretreating media in an aqueous ink jet printing system of claim 1, wherein:
depositing the aqueous solution comprises jetting the aqueous solution from a printhead; and
the aqueous solution is deposited at a drop volume of from about 2 picoliters to about 20 picoliters.

9. The method for pretreating media in an aqueous ink jet printing system of claim 1, wherein the aqueous solution comprises polyvinyl alcohol, a cation, a biocide, or a combination thereof.

10. The method for pretreating media in an aqueous ink jet printing system of claim 1, wherein:
depositing an aqueous solution and depositing the pigmented ink is done with a multichannel printhead; and
the multichannel printhead comprises a first channel and a second channel that are not in fluid communication with one another.

11. A system for pretreating media in an aqueous inkjet printing system, comprising:
a powder deposition device configured to deposit a layer of powder on a surface of the media;
a multichannel printhead, comprising:
a first channel comprising a source of an aqueous solution; and
a second channel comprising a source of a pigmented ink; and
a media path configured to transport the media in proximity to the powder deposition device and the multichannel printhead; and
wherein the first channel and the second channel are not in fluid communication with one another.

12. The system for pretreating media in an aqueous inkjet printing system of claim 11, wherein the media is transported in proximity to the powder deposition device before being transported in proximity to the multichannel printhead.

13. The system for pretreating media in an aqueous inkjet printing system of claim 11, further comprising a sensor to measure a property of the media.

14. The system for pretreating media in an aqueous inkjet printing system of claim 13, wherein the property of the media comprises media absorbency, surface roughness, environmental storage conditions, or a combination thereof.

15. The system for pretreating media in an aqueous inkjet printing system of claim 11, wherein the powder comprises calcium, magnesium, or a combination thereof.

16. The system for pretreating media in an aqueous inkjet printing system of claim 11, wherein the aqueous solution is deposited at a drop volume of from about 2 picoliters to about 20 picoliters.

17. The system for pretreating media in an aqueous inkjet printing system of claim 11, wherein the aqueous solution comprises polyvinyl alcohol, a cation, a biocide, or a combination thereof.

18. An aqueous ink jet printing system, comprising:
a powder deposition device configured to deposit a layer of powder on a surface of a media;
a multichannel printhead, comprising:
a first channel comprising a source of an aqueous solution; and
a second channel comprising a source of a pigmented ink; and
a media path configured to transport the media in proximity to the powder deposition device and the multichannel printhead; and wherein:
the powder comprises calcium, magnesium, or a combination thereof;
the aqueous solution comprises polyvinyl alcohol, a cation, a biocide, or a combination thereof; and
the aqueous solution is deposited at a drop volume of from about 2 picoliters to about 20 picoliters.

19. The aqueous ink jet printing system of claim 18, wherein the first channel and the second channel are not in fluid communication with one another.

20. The aqueous ink jet printing system of claim 18, further comprising a sensor to measure a property of the media.
